(19) United States
(12) Patent Application Publication
(10) Pub. No.: US 2025/0237818 A1
(43) Pub. Date: Jul. 24, 2025

(54) MULTICORE FIBER TRANSMISSION LINE, MULTICORE FIBER TRANSMISSION SYSTEM, AND MULTICORE FIBER CONNECTION METHOD

(71) Applicant: NEC Corporation, Tokyo (JP)

(72) Inventor: Yusuke SASAKI, Tokyo (JP)

(73) Assignee: NEC Corporation, Tokyo (JP)

(21) Appl. No.: 19/011,944

(22) Filed: Jan. 7, 2025

(30) Foreign Application Priority Data
Jan. 24, 2024 (JP) 2024-008897

(51) Int. Cl. G02B 6/36

(52) U.S. Cl. CPC G02B 6/368

(57) ABSTRACT

Provided is a multicore fiber transmission line in which a plurality of MCFs including a first MCF and a second MCF are connected in series with respect to each core, wherein cores of the first MCF and cores of the second MCF to be connected are selected in such a way that a variation in loss among a plurality of cores to be connected between the first MCF and the second MCF is reduced.

This application is based upon and claims the benefit of priority from Japanese patent application No. 2024-008897, filed on Jan. 24, 2024, the disclosure of which is incorporated herein in its entirety by reference.

### TECHNICAL FIELD

The present disclosure relates to a multicore fiber transmission line and a transmission system related to the same, a multicore fiber connection method, and a program.

### BACKGROUND ART

A spatial optical multiplexing transmission system using a multicore fiber (MCF) is being put into practical use. The MCF includes a plurality of cores in one optical fiber. Instead of a single-core fiber (SCF), an MCF is used, and thereby a transmission capacity of an optical transmission system can be expanded.

A loss in an MCF is different with respect to each core. Therefore, in a long-distance MCF transmission line in which a plurality of MCFs are cascade-connected, a loss difference with respect to each core is accumulated, and as a result, power of signal light in an output end of the MCF transmission line may be different to a large extent with respect to each core. Such a variation in power of signal light among cores in the MCF transmission line may degrade transmission quality of an optical transmission system using an MCF.

In order to reduce a variation in power of signal light among cores in an MCF transmission line, a gain flattening filter (GFF) may be used. In case where the GFF is used, a variation in power of signal light among cores of an MCF can be reduced. In a core excitation MC-erbium-doped fiber amplifier (EDFA) in which excitation light is directly injected into a core, excitation light power for each core is adjusted, and thereby a gain of the EDFA can be adjusted for each core. For example, in a core causing a large loss, excitation light power is raised and a gain is increased, and thereby a loss in the core can be compensated.

In relation to the present disclosure, patent literature 1 (PTL 1, Japanese Unexamined Patent Application Publication No. 2016-082318) describes a configuration in which a spatial channel switching element is used, and thereby a connection of cores between MCFs is switched.

### SUMMARY

In the above-described GFF, an additional loss is added to a core having low attenuation, and thereby a level difference in signal light among cores in an MCF transmission line can be reduced. In this case, power of signal light passing through the GFF is attenuated according to a core in which power of signal light is lowest. Therefore, in case where the GFF is used, power of light propagating through an MCF transmission line may be decreased to a large extent. A core pump MC-EDFA causes a problem that, in case when a pump power to a specific core having a low amplification rate is increased, a noise index of the core is worsened, and as a result, a signal-to-noise ratio of light amplified by the core is degraded.

PTL 1 describes a configuration in which, by using a spatial channel switching element (a planar waveguide or a few-mode fiber), beams of signal light among cores are replaced. However, in the technique described in PTL 1, a spatial channel switching element needs to be inserted into each connection point of an MCF. Therefore, the technique described in PTL 1 has a problem that a loss in an entire optical transmission line is increased due to a loss in the switching element.

The present disclosure enables reducing a variation in loss among cores of an MCF transmission line while a loss increase in an optical transmission line is suppressed.

A multicore fiber transmission line according to the present disclosure is a multicore fiber transmission line in which a plurality of multicore fibers including a first multicore fiber and a second multicore fiber are connected in series with respect to each core, wherein
a core of the first multicore fiber and a core of the second multicore fiber to be connected are selected in such a way that a variation in loss among a plurality of cores connected between the first multicore fiber and the second multicore fiber to be reduced.

A multicore fiber connection method according to the present disclosure is a multicore fiber connection method of connecting a plurality of multicore fibers including a first multicore fiber and a second multicore fiber in series with respect to each core, the method including
selecting a core of the first multicore fiber and a core of the second multicore fiber to be connected in such a way that a variation in loss among a plurality of cores connected between the first multicore fiber and the second multicore fiber to be reduced.

The present disclosure provides a technique for reducing a variation in loss among cores of an MCF transmission line while a loss increase in an optical transmission line is suppressed.

### BRIEF DESCRIPTION OF THE DRAWINGS

Exemplary features and advantages of the present invention will become apparent from the following detailed description in case where taken with the accompanying drawings in which:

FIG. 1 is an exemplary diagram illustrating a configuration example of an MCF transmission line;

FIG. 2 is an exemplary diagram illustrating an example of a cross-section of an MCF;

FIG. 3 is an exemplary diagram illustrating a connection example among cores in a connection point;

FIG. 4 is an exemplary diagram illustrating an example of a loss in each core of an MCF and cores connected at a connection point;

FIG. 5 is a flowchart illustrating an example of a procedure of an MCF connection method;

FIG. 6 is an exemplary diagram illustrating a configuration example of an MCF transmission system;

FIG. 7 is a flowchart illustrating an example of a procedure of the MCF connection method;

FIG. 8 is an exemplary diagram illustrating a configuration example of the MCF transmission system; and

FIG. 9 is a flowchart illustrating an example of a control procedure for a control circuit.

### EXAMPLE EMBODIMENT

### First Example Embodiment

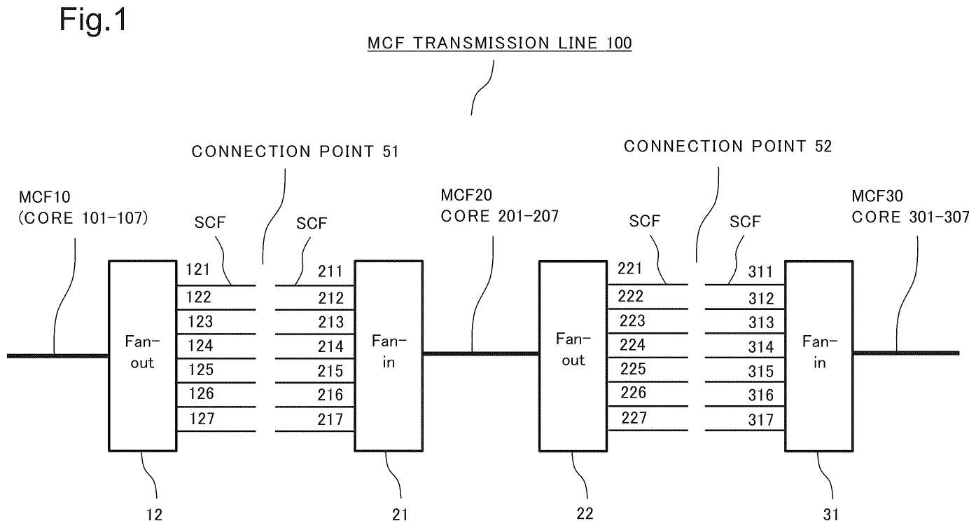

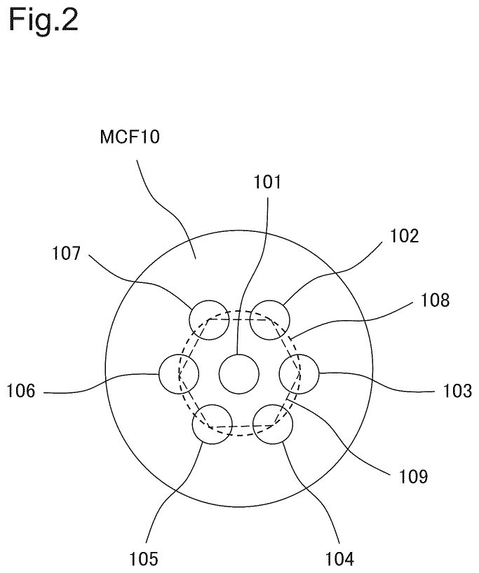

FIG. 1 is a diagram illustrating a configuration example of an MCF transmission line 100 according to a first example embodiment. In the MCF transmission line 100, an MCF 10, an MCF 20, and an MCF 30 are connected in series with respect to each core at connection points 51 and 52. FIG. 2 is a diagram illustrating an example of a cross-section of the MCF 10. Core arrangement of the MCF 20 and the MCF 30 are similar to the MCF 10. The MCF 10 is a seven-core MCF including cores 101 to 107. The cores 102 to 107 are disposed at equal intervals on a circumference 108. In other words, the cores 102 to 107 each are positioned at a vertex of a regular hexagon 108 inscribed in the circumference 108. The core 101 is present in the center of the circumference 108. More generally, in case where n cores (n is an integer equal to or more than 3) are positioned on the circumference 108, the cores on the circumference 108 may be positioned at vertexes of a regular polygon including n vertexes. In other words, FIG. 2 illustrates a case of n=6. Hereinafter, the center (i.e. the center of the circumference 108) of the cross section of an MCF is referred to as the “center of an MCF” or simply as the “center”. For example, the core 101 is positioned in the center of the MCF 10. In case where cores of an MCF are disposed at a plurality of vertexes configuring a square-shaped grating, the center of the grating is assumed to be the center of the MCF.

Description according to each example embodiment does not limit the number of cores or disposition of cores unless otherwise specified. According to the present example embodiment, the cores 101 to 107 in the cross-sectional diagram are referred to as cores 201 to 207 and cores 301 to 307 in the MCFs 20 and 30 each.

Referring to FIG. 1, the MCF 10 includes a fan-out 12 on a connection point 51 side. The MCF 20 includes a fan-in 21 on the connection point 51 side and includes a fan-out 22 on a connection point 52 side. The MCF 30 includes a fan-in 31 on the connection point 52 side. The fan-outs 12 and 22 and the fan-ins 21 and 31 each are a known optical component in which one end is an MCF and another end is an SCF, and generally, are referred to as a fan-in/fan-out. According to the present example embodiment, by using a fan-in/fan-out, the MCF 10 and the MCF 20 are connected with respect to each core, and the MCF 20 and the MCF 30 are connected with respect to each core. Note that in FIG. 1, in connection with respect to each core, for example, fusion-splicing or an optical connector is used.

With regard to a difference between the fan-outs 12 and 22 and the fan-ins 21 and 31, only a disposed direction is different in FIG. 1, and for all of the four optical components, a fan-in/fan-out having the same specification can be used.

SCFs 121 to 127 each are connected to the cores 101 to 107 of the MCF 10 on a one-on-one basis. SCFs 211 to 217 and SCFs 221 to 227 each are connected to the cores 201 to 207 of the MCF 20 on a one-on-one basis. SCFs 311 to 317 each are connected to the cores 301 to 307 of the MCF 30 on a one-on-one basis.

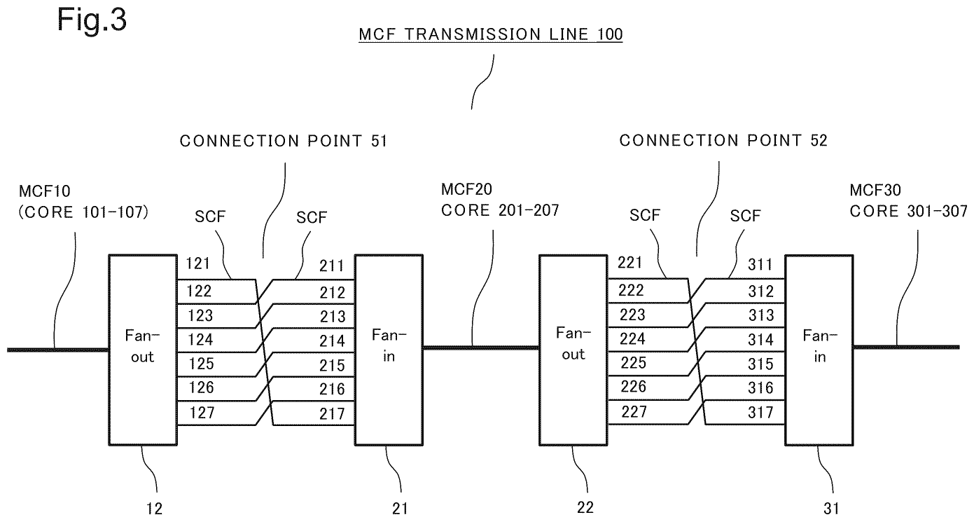

FIG. 3 is a diagram illustrating a connection example among cores at the connection points 51 and 52. In case where the MCF 10 and the MCF 20 are connected, a combination between the SCFs 121 to 127 of the fan-out 12 and the SCFs 211 to 217 of the fan-in 21 to be connected can be arbitrarily selected. In FIG. 3, the SCF 121 and the SCF 217, the SCF 122 and the SCF 211, the SCF 123 and the SCF 212, and the SCF 124 and the SCF 213 are connected. Further, the SCF 125 and the SCF 214, the SCF 126 and the SCF 215, and the SCF 127 and the SCF 216 are connected. In other words, the MCF 10 and the MCF 20 are connected at the connection point 51 in such a way that a core number is shifted by only one. Similarly, the MCF 20 and the MCF 30 are connected at the connection point 52 in such a way that a core number is shifted by only one. The core 101 of the MCF 10 is connected to the core 207 of the MCF 20. The core 201 of the MCF 20 is connected to the core 307 of the MCF 30. Based on such connection, for example, light propagated through the core 101 of the MCF 10 is propagated through the SCF 121, the SCF 217, the core 207, the SCF 227, the SCF 316, and the core 306 in this order.

In a long length MCF, a transmission loss may be different with respect to each core. Therefore, in case where the number (span number) of MCFs connected in series increases, a variation in accumulated loss with respect to each core may increase. Therefore, in the MCF transmission line 100, in case where the MCFs 10, 20, and 30 are connected in series, cores to be connected at the connection points 51 and 52 can be selected in such a way that a variation in accumulated loss with respect to each core after connected is reduced.

For example, a case is assumed in which in the MCF 10, the MCF 20, and the MCF 30, a loss of a center core (the core 101, the core 201, or the core 301) is small, compared with other cores. In such a case, at the connection points 51 and 52, connection may be performed in such a way that the core 101, the core 201, and the core 301 are not connected to each other. Based on such connection, a loss in a path passing through many center cores among the seven cores included in the MCF transmission line 100 can be avoided from becoming excessively smaller than a loss in another path.

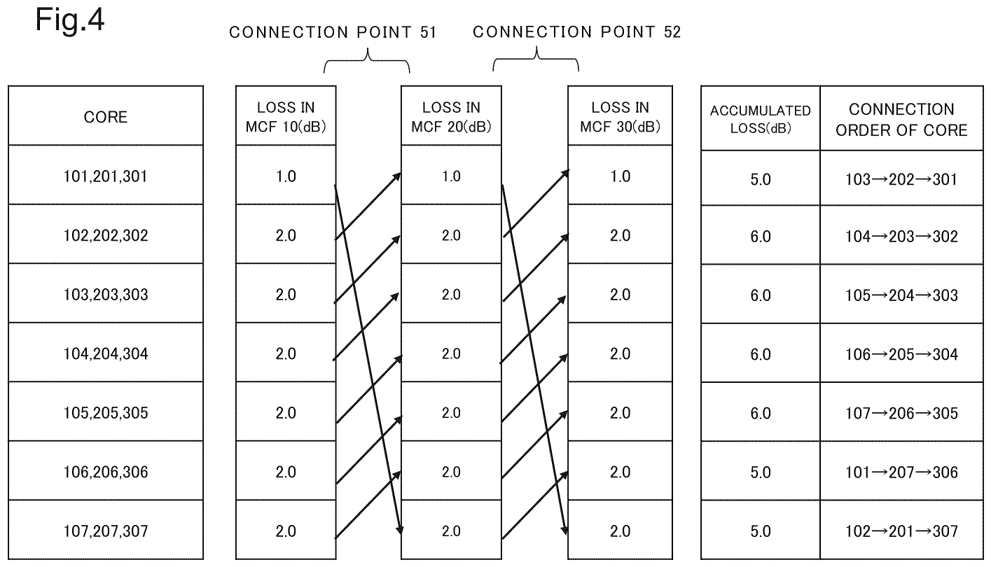

FIG. 4 is a diagram illustrating an example of losses in cores of the MCFs 10, 20, and 30 in FIG. 3 and cores connected at the connection points 51 and 52. The loss in the MCF 10 is a loss in cores between one end of the MCF 10 and the fan-out 12 connected to another end of the MCF 10. The loss in the MCF 20 is a loss in cores between the fan-in 21 and the fan-out 22 connected to the MCF 20. The loss in the MCF 30 is a loss in cores between the fan-in 31 connected to one end of MCF 30 and another end of the MCF 30.

FIG. 4 is an example in which losses in the cores 101, 201, and 301 in the centers of the MCFs 10, 20, and 30 each are 1 dB, and losses in cores other than these cores are 2 dB. The core 101 of the MCF 10 is connected to the core 207 of the MCF 20, and the core 207 is connected to the core 306 of the MCF 30. Other cores are also connected as illustrated in FIG. 4.

In case where, for example, the cores 101, 201, and 301 in which a loss is 1 dB are connected in series, a loss (accumulated loss) in a path where the cores after the connection are connected is 3 dB. In contrast, an accumulated loss in a path of other cores (e.g. a path where the core 102, the core 202, and the core 302 are connected in series) is 2 dB×3=6 dB. Therefore, a difference in accumulated loss among cores in the path after the connection is 3 dB. In contrast, as illustrated in FIG. 4, in case where at the connection points 51 and 52, cores to be connected are switched, an accumulated loss in seven paths after the connection each is 5 dB or 6 dB. In other words, a variation in accumulated loss among cores is reduced to 1 dB. Note that a combination of SCFs connecting the fan-out 12 and the fan-in 21 at the connection point 51 is not limited to the example in FIG. 4. The same applies to the connection point 52.

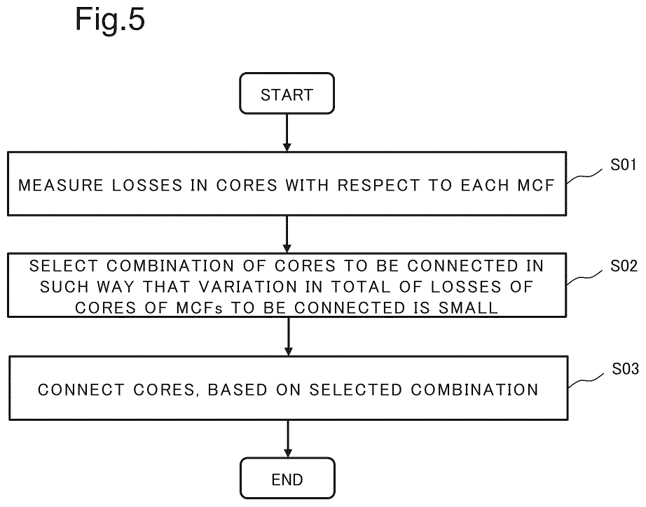

A combination of cores to be connected at the connection points 51 and 52 may be determined based on a procedure illustrated in the flowchart of FIG. 5. In other words, losses in cores are previously measured for each of MCFs (the MCFs 10, 20, and 30) to be connected (step S01 in FIG. 5). Then, a combination of cores to be connected in which a variation of a total loss in cores of MCFs to be connected is small is selected (S02). Herein, a combination in which the variation is smallest may be selected, or a combination of cores in which the variation is equal to or less than a predetermined value may be selected. Finally, based on the selected combination, cores are connected (S03).

In case where there are three or more MCFs to be connected in series, in step S02, a combination of cores to be connected may be determined with respect to each connection point in such a way that a variation in loss among cores of two adjacent MCFs is small. Or, a combination of cores for each connection point may be determined in such a way that a variation in accumulated loss with respect to each core in which all MCFs are connected in series is small. As described above, the MCF transmission line and the connection method for MCFs according to the present example embodiment can reduce a variation in loss among cores of an MCF transmission line while a loss increase in an optical transmission line is reduced.

The MCF transmission line 100 including the above-described feature and exhibiting a similar advantageous effect may be described as below. In parentheses, a reference sign in FIG. 1 is indicated.

A multicore fiber transmission line (100) is a multicore fiber transmission line in which a plurality of multicore fibers including a first multicore fiber (10) and a second multicore fiber (20) are connected in series with respect to each core. A core of the first multicore fiber (10) and a core of the second multicore fiber (20) to be connected are selected in such a way that a variation in loss among a plurality of cores to be connected between the first multicore fiber (10) and the second multicore fiber (20) is reduced.

The multicore fiber transmission line (100) may include a fan-out (12) connected to the first multicore fiber (10) and a fan-in (21) connected to the second multicore fiber (20). Connection between the first multicore fiber (10) and the second multicore fiber (20) may be performed between a single-core fiber included in the fan-out (12) and a single-core fiber included in the fan-in (21).

### Another Example of First Example Embodiment

In case where two MCFs are connected, in each of the two MCFs, a fusion-spliced point of MCFs may be included. For example, as described later, in case where MCFs are directly fusion-spliced, due to a deviation in a rotational angle direction at a time of rotation alignment, a connection loss in outer cores of an MCF may increase, compared with cores in a center vicinity of the MCF. As a result, a loss in an MCF including a fusion-spliced part may increase in an outer core.

In case where such two MCFs in which a core in a center vicinity of an MCF and an outer core of the MCF are different in loss are connected, the cores may be connected at a connection point in such a way that the core in the center vicinity and the outer core are switched. For example, in the configuration example illustrated in FIG. 3, at the connection points 51 and 52, a center core and an outer circumference core are switched and the switched cores are connected with respect to each connection point of MCFs. As a result, in the configuration of FIG. 3, in the MCF transmission line 100 in which MCFs are connected in series, a difference in accumulated loss between a center vicinity core and an outer circumference core of an MCF can be reduced.

### Second Example Embodiment

According to the present example embodiment, an example of a procedure of directly fusion-splicing MCFs closely opposed, without a fan-out and a fan-in is described.

In case where MCFs in which cores are disposed around a center are directly connected by fusion-splicing, a procedure of rotating the MCFs around the center axis and fusion-splicing the MCFs at an angle in which a loss of light propagated through the cores is minimized may be used. Such a procedure for core position adjustment is hereinafter referred to as “rotation alignment”. In core position adjustment of an MCF based on rotation alignment, a connection loss (Loss) in each core is indicated by expression (1).

$$Loss = 10 \times log [ exp ( {d}^{2} / {w}^{2} ) ] ( dB ) \qquad ( 1 )$$

Herein, d is an axis deviation amount of a core at a time of connection, and w is MFD/2. The MFD is a mode field diameter of a core. In contrast, an axis deviation amount d between opposed cores present on a concentric circle having a radius r is indicated by expression (2) in which an angle deviation amount of θ.

$$d = r \times θ \qquad ( 2 )$$

An angle deviation amount θ is an angle formed by opposed cores with respect to a rotational axis (i.e. the center of an MCF) immediately before fusion-splicing. Expression (1) indicates that a connection loss (Loss) increases with an axis deviation amount d.

Expression (2) indicates that an axis deviation amount d with respect to an angle deviation amount θ at a time of alignment increases with departing from the center of an MCF. Therefore, at a time of performing rotation alignment, in case where an MCF is connected while an angle deviation amount is θ, a connection loss in a core disposed in a position close to an outer circumference of the MCF is larger than a connection loss of a core disposed on a more inner side. Therefore, in case where based on rotation alignment, MCFs are directly connected, due to a difference in the above-described connection loss, a loss in a path where cores in a center vicinity of the MCFs are connected may be small and a loss in a path where cores disposed in a position close to an outer circumference of the MCFs are connected may be large. Therefore, also in case where MCFs are directly fusion-spliced based on rotation alignment, in the MCFs after the fusion-splicing, preferably, a variation in loss among cores can be reduced.

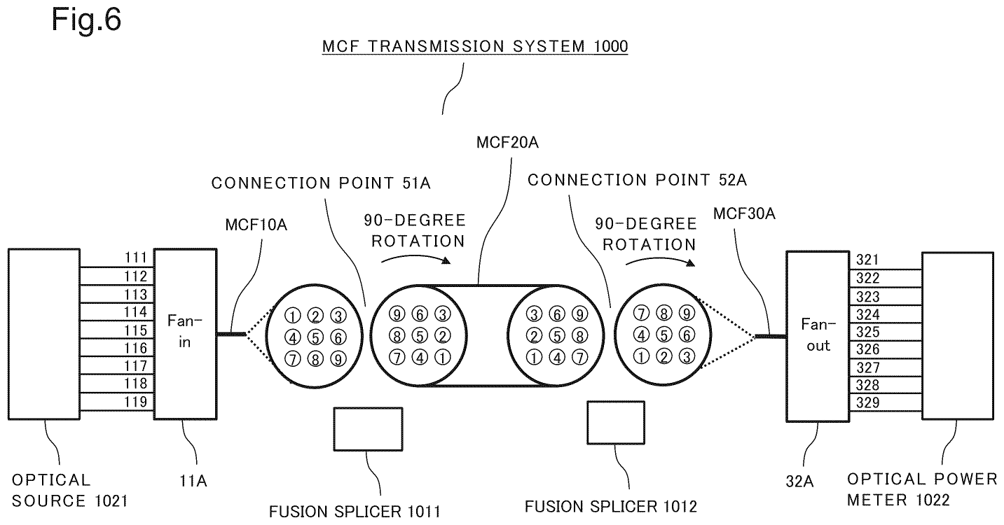

FIG. 6 is a diagram illustrating a configuration example of a multicore fiber transmission system (MCF transmission system) 1000 in which MCFs 10A, 20A, and 30A are connected in series. According to the present example embodiment, the MCF 10A is a nine-core MCF, and in FIG. 6, core numbers of each MCF are referred to as 1 to 9. The nine cores are positioned at a plurality of grating points of three rows×three columns. Intervals of columns and rows configuring the plurality of gratins points are the same, and the plurality of grating points configure one square grating. The MCFs 20A and 30A also form the same core disposition as the MCF 10A. The core 5 is positioned in the center of the MCFs 10A, 20A, and 30A. Therefore, at a connection point 51A between the MCF 10A and the MCF 20A, in case where either of the MCFs 10A and 20A is rotated around the core 5, a position of another core is overlapped at every 90 degrees. In other words, core disposition of the MCFs 10A, 20A, and 30A forms rotational symmetry (four-fold symmetry) around the center of each MCF. At a rotational angle where positions of cores are overlapped, cores can be fusion-spliced while optically connected.

In a vicinity of the connection point 51A, a fusion splicer 1011 is disposed, and in a vicinity of the connection point 52A, a fusion splicer 1012 is disposed. The fusion splicers 1011 and 1012 each include a function for rotation alignment and connect MCFs by fusion-splicing after termination of rotation alignment. The fusion-splicing is performed, for example, by using arc discharge. The fusion splicer 1011 includes a mechanism of holding an end portion of the MCF 10A and an end portion of the MCF 20A at the connection point 51A and performing core position adjustment in such a way that a core of the MCF 10A and a core of the MCF 20A are optically coupled. The fusion splicer 1012 includes a function similar to the fusion splicer 1011. The mechanism for core position adjustment included in the fusion splicers 1011 and 1012 includes a mechanism for rotation alignment. The mechanism for rotation alignment is a mechanism of causing, on a straight line, a cross-section of one MCF and a cross-section of another MCF to be opposed to each other and rotating, on the straight line, the cross-section of the one MCF with respect to the cross-section of the another MCF. The straight line is a straight line passing through the centers of both MCFs. The fusion splicers 1011 and 1012 including such a mechanism play a role in a fusing means configured to fusion-splice MCFs.

An optical source 1021 outputs reference light of a predetermined transmission power to one of SCFs 111 to 119 of a fan-in 11A. The optical source 1021 includes light-emitting elements and a 1×9 optical switch and may select, by using the optical switch, any one of the SCFs 111 to 119 of the fan-in 11A to be a connection destination of one light-emitting element. An optical power meter 1022 receives reference light transmitted by the optical source 1021 and measures power of the received light. The optical power meter 1022 may previously store internally, as data, a value of transmission power of the reference light. Thereby, the optical power meter 1022 calculates, from a difference between transmission power and reception power of the reference light, a loss of the reference light propagated through a path including points to be connected. The reference light is propagated through only one core in each of the MCFs 10A, 20A, and 30A. Therefore, in case where power of the reference light in the optical power meter 1022 is measured, the fan-out 32A is not necessarily required. For example, an end surface of the MCF 30A is directly connected to the optical power meter 1022, and thereby power of the reference light output from the MCF 30A may be measured. The optical power meter 1022 plays a role in a loss measurement means configured to measure losses before connection between the MCF 10A and the MCF 20A and before connection between the MCF 20A and the MCF 30A.

A rotational angle is changed from an initial position by every 90 degrees in case where rotation alignment is performed at the connection points 51A and 52A, and thereby in the MCFs 10A, 20A, and 30A, a path using different cores is configured. The initial position is a position where cores of opposed MCFs are opposed to each other with the same core number. With regard to disposition of cores at the connection point 51A of FIG. 6, as an example, a state where a core position of the MCF 20A opposed to the MCF 10A is rotated in a 90-degree right direction from an initial position is illustrated. In this case, cores 1, 2, and 3 each of the MCF 10A are opposed to cores 3, 6, and 9 of the MCF 20A. The same applies to other cores. In case where in this state, the MCF 10A and the MCF 20A are fusion-spliced, cores 1 to 9 each of the MCF 10A are connected to cores 3, 6, 9, 2, 5, 8, 1, 4, and 7 of the MCF 20A. In case where a rotational angle of the MCF 20A is further increased by every 90 degrees, a connection relation among cores can be caused to be further different. Therefore, by using the rotation alignment function of the fusion splicer 1011, a connection relation among cores can be modified between the MCF 10A and the MCF 20A. Similarly, by using the rotation alignment function of the fusion splicer 1012, a connection relation can be modified between the MCF 20A and the MCF 30A.

According to the present example embodiment, the optical source 1021 sequentially transmits reference light to nine cores every time at the connection points 51A and 52A, one MCF is rotated by 90 degrees clockwise or counterclockwise from an initial position. The optical power meter 1022 measures and outputs a loss in each core of the reference light in each of connection states among the MCFs 10A, 20A, and 30A. A worker operating the fusion splicers 1011 and 1012 selects, from measurement results of losses with respect to each rotational angle and each core, rotational angles at the connection points 51A and 52A to be set at a time of fusion-splicing. The selected rotational angle is a rotational angle at each of the connection points 51A and 52A in case where, for example, a variation in loss among cores is smallest. A worker operates the fusion splicers 1011 and 1012 and fusion-splices the MCF 10A and the MCF 20A, as well as the MCF 20A and the MCF 30A at angles each. A rotational angle may be selected by the optical power meter 1022 or a control circuit connected to this meter. Based on such a procedure, a variation in loss with respect to each core after connection of the MCFs 10A, 20A, and 30A can be reduced. In other words, the MCF transmission system 1000 according to the present example embodiment can reduce a variation in loss among cores of an MCF transmission line while a loss increase in an optical transmission line is reduced.

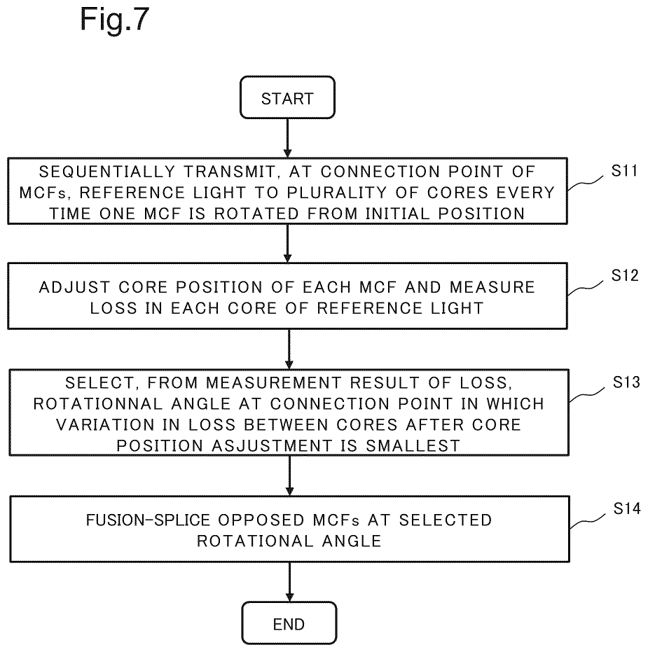

FIG. 7 is a flowchart illustrating an example of a procedure for a connection method for MCFs according to the present example embodiment. Every time one opposed MCF at a connection point between MCFs is rotated by a predetermined angle from an initial position, reference light is sequentially transmitted to a plurality of cores (step S11 in FIG. 7). In a state where a core position of the MCF is adjusted, a loss in each core of the reference light is measured (S12). From measurement results of losses with respect to each rotational angle and each core, a rotational angle at the connection point in which a variation in loss among cores after core position adjustment is smallest is selected (S13), and at the selected rotational angle, opposed MCFs are fusion-spliced (S14). Herein, the selected rotational angle is a combination of a rotational angle at the connection point 51A and a rotational angle at the connection point 52A.

The above-described connection procedure for MCFs measures, while a rotational angle is changed, a total loss in the MCFs 10A, 20A, and 30A and determines a rotational angle at the connection points 51A and 52A each. Instead of the procedure, first, the optical power meter 1022 is disposed at the connection point 52A and based on a procedure similar to the above-described procedure, a preferable rotational angle is found between the MCF 10A and the MCF 20A, and thereby rotation alignment and fusion-splicing may be performed. Then, between the MCF 20A and the MCF 30A, rotation alignment and fusion-splicing may be performed similarly. In this case, reference light transmitted by the optical source 1021 propagates through the MCF 10A and the MCF 20A, appears at the connection point 52A, propagates through the MCF 30A, and then is received in the optical power meter 1022.

### Third Example Embodiment

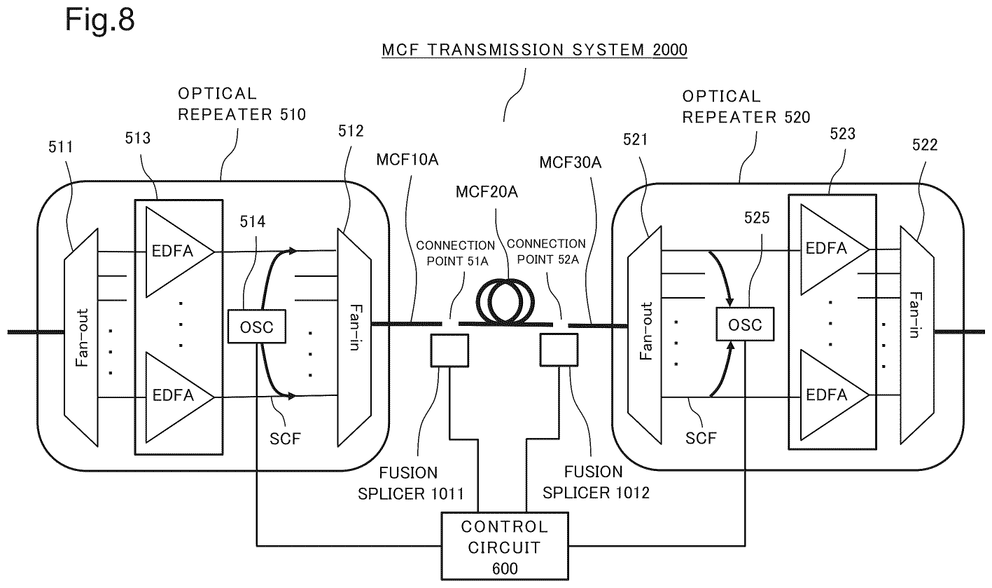

FIG. 8 is a diagram illustrating a configuration example of an MCF transmission system 2000. The MCF transmission system 2000 is an optical transmission system in which an optical repeater 510 and an optical repeater 520 are connected by MCFs 10A, 20A, and 30A. The optical repeaters 510 and 520 each include an optical amplification function of amplifying signal light. Optical fibers for input/output of the optical repeaters 510 and 520 each are an MCF. The MCF 10A, the MCF 20A, and the MCF 30A each are a nine-core MCF illustrated in FIG. 6.

The optical repeater 510 includes a fan-out 511 for input and a fan-out 512 for output. Between the fan-out 511 and the fan-in 512, an optical amplifier 513 is disposed. The optical amplifier 513 includes erbium-doped fiber amplifiers (EDFAs), disposed in parallel, of the same number as the number of cores of MCF 10A. An input/output interface of each EDFA is an SCF. An input side of the optical amplifier 513 is connected to the fan-out 511 by nine SCFs, and an output side of the optical amplifier 513 is connected to the fan-in 512 by nine SCFs. An optical transmission circuit 514 couples reference light with one SCF selected from the nine SCFs included in the fan-in 512. The reference light has a wavelength (e.g. 1510 nm) being not overlapped with that of signal light, and is coupled with signal light amplified by an EDFA and transmitted in a direction of the MCF 10A.

A configuration of the optical repeater 520 is different from the optical repeater 510 in that instead of the optical transmission circuit 514, an optical reception circuit 525 is included. Functions of a fan-out 521, a fan-in 522, and an optical amplifier 523 are relevant to the fan-out 511, the fan-in 512, and the optical amplifier 513 of the optical repeater 510. The optical reception circuit 525 includes a function of selecting, for each core, reference light input from the MCF 30A, receiving the selected reference light, and measuring power of the received reference light.

The optical transmission circuit 514 and the optical reception circuit 525 may be included in a general optical monitoring circuit using an optical supervisory channel (OSC). As reference light, monitoring light transmitted by the OSC may be used. In an optical repeater, a configuration in which monitoring light and signal light are multiplexed and a configuration in which monitoring light and signal light are demultiplexed are well-known, and therefore detailed description of multiplexing and demultiplexing of reference light and signal light is omitted.

The optical repeater 510 and the optical repeater 520 are connected by the MCFs 10A, 20A, and 30A. Cores of the MCF 10A are connected to SCFs of the fan-in 512 included in the optical repeater 510. Cores of the MCF 30A are connected to SCFs of the fan-out 521 included in the optical repeater 520. A connection point 51A between the MCF 10A and the MCF 20A and a connection point 52A between the MCF 20A and the MCF 30A each include fusion splicers 1011 and 1012 including a rotation alignment function. A control circuit 600 is an electric circuit communicably connected to the optical transmission circuit 514, the optical reception circuit 525, and the fusion splicers 1011 and 1012. The control circuit 600 controls some or all of the devices connected.

The optical transmission circuit 514 of the optical repeater 510 selects one of the nine SCFs of the fan-in 512 and outputs reference light to the selected SCF. The reference light input to the selected SCF is propagated through a core of the MCF 10A connected to the SCF and propagated through the MCF 20A and the MCF 30A via gaps at the connection points 51A and 52A. The optical reception circuit 525 receives the reference light transmitted by the optical transmission circuit 514 from an SCF of the fan-out 521 connected to the core through which the reference light is propagated and calculates, based on a difference between transmission power and reception power of the reference light, a loss in a path through which the reference light is propagated.

At that time, every time at the connection points 51A and 52A, one MCF is rotated by a predetermined angle from an initial position, the optical transmission circuit 514 sequentially transmits reference light to each one of the nine SCF cores of the fan-in 512. The optical reception circuit 525 measures, in each case, a loss in a path through which the reference light is propagated. The control circuit 600 selects, from a measurement result of the loss, a rotational angle at a connection point where a variation in loss in a path is smallest.

When a loss in a path is calculated, a loss in an inner path of the optical repeaters 510 and 520 may be compensated. The calculated loss is notified to the control circuit 600 via a communication line. The calculation of a loss may be performed in the control circuit 600.

The control circuit 600 may issue an instruction to the optical transmission circuit 514 for an SCF to which reference light is transmitted and transmission power of the reference light. In this case, the control circuit 600 may determine, from a difference between the transmission power and power of the reference light measured in the optical reception circuit 525 after transmission of the reference light, a loss in cores of the MCFs 10A, 20A, and 30A connected to the selected SCF. Or, transmission power of reference light transmitted by the optical transmission circuit 514 may have a fixed value defined in the MCF transmission system 2000.

The optical reception circuit 525 may acquire, based on communication using a communication line, information of a number of an SCF (i.e. a number of a core) selected by the optical transmission circuit 514 and core numbers of MCFs opposed at the connection points 51A and 52A. The optical reception circuit 525 may transmit, to the control circuit 600, these pieces of information in association with one another. The optical reception circuit 525 may acquire, from the optical transmission circuit 514, a number of an SCF selected by the optical transmission circuit 514. The optical reception circuit 525 may acquire, from the fusion splicers 1011 and 1012, information of core numbers of MCFs opposed at the connection points 51A and 52A. The information of core numbers of opposed MCFs may be set by a worker for the fusion splicers 1011 and 1012.

The optical reception circuit 525 selects, by using an optical switch, an SCF for which reception power of reference light is measured and may determine an SCF of the fan-out 521 to which reference light is transmitted. In the optical reception circuit 525, in case where a core in which reference light is received cannot be determined, the optical reception circuit 525 sequentially switches an SCF for which reception power of reference light is measured and may search an SCF for which the reference light is detected.

The optical transmission circuit 514 transmits reference light to a selected SCF. The fusion splicer 1011 performs core position adjustment in such a way that a core of the MCF 10A and a core of the MCF 20A are optically coupled. The fusion splicer 1012 performs core position adjustment in such a way that a core of the MCF 20A and a core of the MCF 30A are optically coupled. Reference light is propagated through one core of the MCFs 10A, 20A, and 30A each and received in the optical reception circuit 525. As a result, from a difference between transmission power of reference light and reception power of the reference light in the optical reception circuit 525, a loss in a propagation path of the reference light is determined.

The procedure for loss measurement described above is executed for nine cores in which at the connection point 51A, a rotational angle is set to be zero degree, 90 degrees, 180 degrees, and 270 degrees. Further, loss measurement is performed for nine cores in which at the connection point 52A, a rotational angle is set to be zero degree, 90 degrees, 180 degrees, and 270 degrees. The control circuit 600 controls the fusion splicers 1011 and 1012 and controls a rotational angle at the connection points 51A and 52A. The control circuit 600 acquires, from the optical reception circuit 525 and the fusion splicers 1011 and 1012, information of measured losses and information of a rotational angle at each of the connection points 51A and 52A at that time. The control circuit 600 generates data of a measured loss for each core with respect to each combination of a rotational angle at the connection point 51A and a rotational angle at the connection point 52A. The control circuit 600 extracts, from data of the losses, a rotational angle at the connection point 51A and a rotational angle at the connection point 52A in which a variation with respect to each core is smallest. The control circuit 600 outputs an instruction to the fusion splicer 1011 for fusion splicing between the MCF 10A and the MCF 20A at the extracted rotational angle at the connection point 51A. Further, the control circuit 600 outputs an instruction to the fusion splicer 1012 for fusion splicing between the MCF 20A and the MCF 30A at the extracted rotational angle at the connection point 52A.

In this manner, the MCF transmission system 2000 selects a rotational angle in which a variation in loss among cores is small and fusion-splices, at the angle, the MCF 10A and the MCF 20A, as well as the MCF 20A and the MCF 30A. As a result, a variation in loss among cores caused after the MCFs 10A, 20A, and 30A are connected can be reduced.

The above-described connection procedure for MCFs, similarly to the second example embodiment, actually measures a total loss in the MCFs 10A, 20A, and 30A while a rotational angle is changed with respect to each core and performs optical axis adjustment in such a way that each of rotational angles at the connection points 51A and 52A has a preferable value.

According to the present example embodiment, the optical transmission circuit 514, the optical reception circuit 525, and the fusion splicers 1011 and 1012 are communicably connected to the control circuit 600. The control circuit 600 controls these devices and thereby, can automatically perform fusion-splicing between MCFs at the connection points 51A and 52A. The control circuit 600 may be a computer including a CPU and a storage device. The control circuit 600 executes a program stored in the storage device and thereby, may achieve a part or the whole of the control circuit 600.

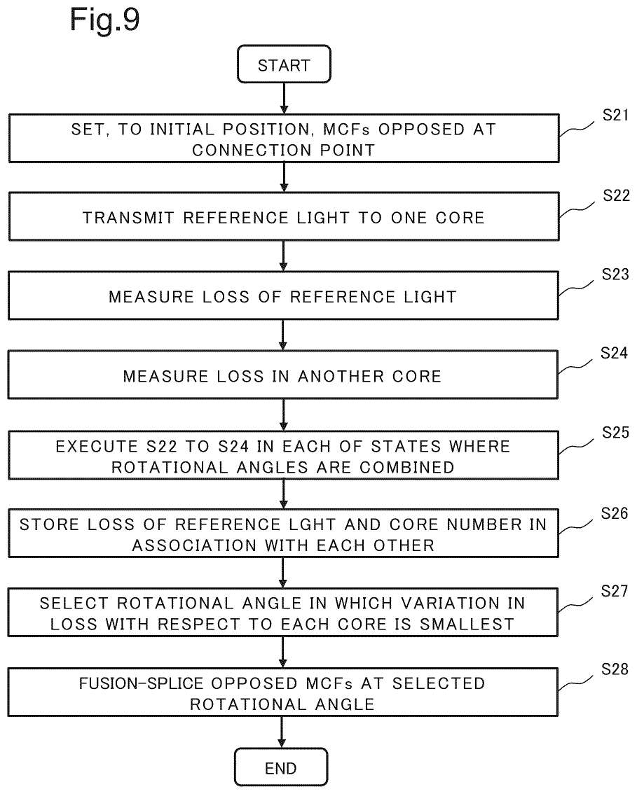

FIG. 9 is a flowchart illustrating one example of a control procedure of connecting the MCF 10A, the MCF 20A, and the MCF 30A in the control circuit 600. The control circuit 600 controls the fusion splicers 1011 and 1012 in such a way that cores having the same core number of MCFs opposed at the connection points 51A and 52A of the MCFs have opposed positions (initial positions) (step S21 in FIG. 9). Based on the control, between the MCFs opposed at the connection points 51A and 52A, cores having the same core number are opposed to each other.

The control circuit 600 controls the optical transmission circuit 514 in such a way as to transmit reference light to one of cores (i.e. one of SCFs of the fan-in 512) of the MCF 10A (S22). The control circuit 600 receives the reference light and controls the optical reception circuit 525 in such a way as to measure a loss of the reference light (S23). The control circuit 600 repeats steps S22 and S23 for other cores of the MCF 10A (S24).

The control circuit 600 controls the fusion splicers 1011 and 1012 and modifies rotational angles at the connection point 51A and the connection point 52A independently of each other. The control circuit 600 measures, at the modified rotational angles, a loss in a configured path. Specifically, the control circuit 600 executes measurement in steps S22 to S24 in each of states where among combinations of a rotational angle at the connection point 51A and a rotational angle at the connection point 52A, rotational angles except for an initial state are combined (S25). In case where among combinations of rotational angles, there is a combination of rotational angles in which it is previously clear that it is difficult to be configured as a path, the combination of rotational angles may be excluded from a schedule for loss measurement. For example, in case where there are a plurality of cores in which it is already known that their losses are large, a combination in which such cores are connected may be excluded from loss measurement.

A measurement result of a loss of reference light is notified from the optical reception circuit 525 to the control circuit 600. The measurement result of a loss is stored in the control circuit 600 in association with a condition at a time of the measurement. The measurement condition at a time of loss measurement includes at least a rotational angle at each of the connection points 51A and 52A in case where measured. The control circuit 600 stores information indicating disposition of a core relevant to a core number. In an initial state, the MCF 10A, the MCF 20A, and the MCF 30A configure a path in such a way that cores having the same core number are opposed to each other. Therefore, a core number of a core through which reference light is propagated at a time of measurement of a loss can be known from information of disposition of cores and rotational angles at the connection points 51A and 52A. In this manner, the control circuit 600 can store a loss of reference light and core numbers of the MCF 10A, the MCF 20A, and the MCF 30A configuring a path relevant to the loss in association with each other (S26).

The control circuit 600 selects, from a measurement result of a loss with respect to each rotational angle and each core, a rotational angle configuring a path where a variation in loss with respect to each core is smallest from among paths configured by the MCF 10A, the MCF 20A, and the MCF 30A (S27). Or, the control circuit 600 may select a rotational angle configuring a path where a variation in loss with respect to each core is equal to or less than a predetermined value. The selected rotational angle is a combination of a rotational angle at the connection point 51A and a rotational angle at the connection point 52A. The control circuit 600 controls, at the selected rotational angle, the fusion splicers 1011 and 1012 in such a way as to fusion-splice opposed MCFs (S28).

According to the second and third example embodiments, as an example, a case where the MCFs 10A, 20A, and 30A each are a nine-core MCF of three rows×three columns has been described. However, disposition of cores of an MCF is not limited thereto. The procedure for core position adjustment according to the second and third example embodiments is applicable to connection of MCFs in which disposition of cores is rotationally symmetrical to the center of the MCFs each. In other words, an MCF of core disposition in which the MCF is rotated around the center and thereby positions of cores around the center are overlapped is applicable with the connection procedure according to the second example embodiment, and a similar advantageous effect is exhibited.

In other words, according to the second and third example embodiment, dispositions of cores of the MCFs 10A, 20A, and 30A are the same, and cores other than a core in the center of the MCFs 10A, 20A, and 30A are disposed in positions rotationally symmetrical to the center. FIG. 6 indicates that at the connection point 51A, a core of the MCF 10A and a core of the MCF 20A are connected while opposed to each other in positions which are rotationally symmetrical. Further, FIG. 6 indicates that at the connection point 52A, a core of the MCF 20A and a core of the MCF 30A are similarly connected while opposed to each other in positions which are rotationally symmetrical.

For example, in an MCF in which a core is disposed at each of vertexes of one or a plurality of regular hexagons having, as its center, the center of the MCF, core disposition forms rotational symmetry of six-fold symmetry. Therefore, such a six-core MCF is applicable to the MCF transmission system according to the second and third example embodiments. In this case, every time the six-core MCF is rotated by 60 degrees from an initial position, paths based on a combination of different cores are configured. Then, for the paths each, a loss is measured and a core having small loss variation is selected, and thereby also in a six-core MCF, an advantageous effect similar to the second and third example embodiments is exhibited. Further, a procedure relevant to this case is applicable to a case where a core is disposed at each of vertexes of another regular polygon other than a regular hexagon and the center of the regular polygon is present in the center of an MCF.

The example embodiments according to the present disclosure can be described as, but not limited to, the following supplementary notes.

### Supplementary Note 1

A multicore fiber transmission line in which a plurality of multicore fibers including a first multicore fiber and a second multicore fiber are connected in series with respect to each core, wherein a core of the first multicore fiber and a core of the second multicore fiber to be connected are selected in such a way that a variation in loss among a plurality of cores to be connected between the first multicore fiber and the second multicore fiber is reduced.

### Supplementary Note 2

The multicore fiber transmission line according to supplementary note 1, further including a fan-out connected to the first multicore fiber and a fan-in connected to the second multicore fiber, wherein the connection is performed between a single-core fiber included in the fan-out and a single-core fiber included in the fan-in.

### Supplementary Note 3

The multicore fiber transmission line according to supplementary note 2, wherein a core of the first multicore fiber and a core of the second multicore fiber to be connected are selected based on a connection relation between a single-core fiber included in the fan-out and a single-core fiber included in the fan-in.

### Supplementary Note 4

The multicore fiber transmission line according to supplementary note 1, wherein
the core of the first multicore fiber and the core of the second multicore fiber are disposed on a plurality of concentric circles in which a center of each multicore fiber is a center, and
some or all of cores to be connected are selected from cores disposed on the concentric circles having radii different from one another.

### Supplementary Note 5

The multicore fiber transmission line according to supplementary note 1, wherein disposition of the core of the first multicore fiber and disposition of the core of the second multicore fiber are same, and the cores are disposed in positions forming rotational symmetry with respect to a center.

### Supplementary Note 6

The multicore fiber transmission line according to supplementary note 5, wherein the core of the first multicore fiber and the core of the second multicore fiber are connected while being opposed to each other in the rotationally symmetrical positions.

### Supplementary Note 7

The multicore fiber transmission line according to any one of supplementary notes 1 to 6, wherein the core of the first multicore fiber and the core of the second multicore fiber are connected by fusion-splicing.

### Supplementary Note 8

The multicore fiber transmission line according to any one of supplementary notes 1 to 4, wherein the core of the first multicore fiber and the core of the second multicore fiber are connected by an optical connector.

### Supplementary Note 9

A multicore fiber transmission system including:
the multicore fiber transmission line according to any one of supplementary notes 1 to 6;
a loss measurement means configured to measure the loss before the connection; and
a fusion-splicing means configured to directly fusion-splice the first multicore fiber and the second multicore fiber.

### Supplementary Note 10

The multicore fiber transmission system according to supplementary note 9, wherein the fusion-splicing means includes a mechanism of causing a cross-section of the first multicore fiber and a cross-section of the second multicore fiber to be opposed to each other on a straight line and rotating, on the straight line, the cross-section of the second multicore fiber with respect to the cross-section of the first multicore fiber.

### Supplementary Note 11

The multicore fiber transmission system according to supplementary note 10, wherein the fusion-splicing means performs the fusion-splicing at an angle of the rotation in which a variation of the loss on a path constituted of the connected cores is reduced.

### Supplementary Note 12

The multicore fiber transmission system according to any one of supplementary notes 9 to 11, wherein the loss measurement means measures, for each core, the loss by using reference light propagating through a point subjected to the fusion-splicing.

### Supplementary Note 13

A multicore fiber connection method of connecting a plurality of multicore fibers including a first multicore fiber and a second multicore fiber in series with respect to each core, the method including selecting a core of the first multicore fiber and a core of the second multicore fiber to be connected in such a way that a variation in loss among a plurality of cores to be connected between the first multicore fiber and the second multicore fiber is reduced.

### Supplementary Note 14

The multicore fiber connection method according to supplementary note 13, further including performing the connection between a single-core fiber included in a fan-out connected to the first multicore fiber and a single-core fiber included in a fan-in connected to the second multicore fiber.

### Supplementary Note 15

The multicore fiber connection method according to supplementary note 14, further including selecting a core of the first multicore fiber and a core of the second multicore fiber to be connected, based on a connection relation between a single-core fiber included in the fan-out and a single-core fiber included in the fan-in.

### Supplementary Note 16

The multicore fiber connection method according to supplementary note 13, further including:

disposing the core of the first multicore fiber and the core of the second multicore fiber on a plurality of concentric circles in which a center of each multicore fiber is a center; and selecting some or all of cores to be connected from among cores disposed on the concentric circles having radii different from one another.

### Supplementary Note 17

The multicore fiber connection method according to supplementary note 13, wherein disposition of the core of the first multicore fiber and disposition of the core of the second multicore fiber are same, and the cores are disposed in positions forming rotational symmetry with respect to a center.

### Supplementary Note 18

The multicore fiber connection method according to any one of supplementary notes 13 to 17, further including connecting, by fusion-splicing, the core of the first multicore fiber and the core of the second multicore fiber.

### Supplementary Note 19

The multicore fiber connection method according to any one of supplementary notes 13 to 18, further including:
measuring the loss before the connection; and
directly fusion-splicing the first multicore fiber and the second multicore fiber.

### Supplementary Note 20

The multicore fiber connection method according to supplementary note 19, further including:
causing a cross-section of the first multicore fiber and a cross-section of the second multicore fiber to be opposed to each other on a straight line; and
rotating, on the straight line, the cross-section of the second multicore fiber with respect to the cross-section of the first multicore fiber.

### Supplementary Note 21

The multicore fiber connection method according to supplementary note 19 or 20, further including performing the fusion-splicing at an angle of the rotation in which a variation of the loss in a path constituted of the connected cores is reduced.

### Supplementary Note 22

The multicore fiber connection method according to any one of supplementary notes 13 or 21, further including measuring, for each core, the loss by using reference light propagating through a point subjected to the fusion-splicing.

### Supplementary Note 23

A program causing a computer of a multicore fiber transmission system configured by connecting in series, for each core, a plurality of multicore fibers including a first multicore fiber and a second multicore fiber to execute a procedure of selecting a core of the first multicore fiber and a core of the second multicore fiber to be connected in such a way that a variation in loss among a plurality of cores to be connected between the first multicore fiber and the second multicore fiber is reduced.

### Supplementary Note 24

The program according to supplementary note 23, including a procedure of measuring, for each core, the loss by using reference light propagating through a point subjected to the fusion-splicing.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, the multicore fiber transmission line and the multicore fiber transmission system according to each example embodiment also disclose a multicore fiber connection method and a program including a part or the whole of the procedure.

Configurations described according to the example embodiments are not necessarily exclusive to each other. Actions and advantageous effects according to the present disclosure may be achieved by a configuration acquired by combining the whole or a part of the above-described example embodiments.

1. A multicore fiber transmission line in which a plurality of multicore fibers including a first multicore fiber and a second multicore fiber are connected in series with respect to each core, wherein
a core of the first multicore fiber and a core of the second multicore fiber to be connected are selected in such a way that a variation in loss among a plurality of cores to be connected between the first multicore fiber and the second multicore fiber is reduced.

2. The multicore fiber transmission line according to claim 1, further comprising
a fan-out connected to the first multicore fiber and a fan-in connected to the second multicore fiber, wherein
the connection is performed between single-core fibers included in the fan-out and single-core fibers included in the fan-in.

3. The multicore fiber transmission line according to claim 2, wherein a core of the first multicore fiber and a core of the second multicore fiber to be connected are selected based on a connection relation between single-core fibers included in the fan-out and single-core fibers included in the fan-in.

4. The multicore fiber transmission line according to claim 1, wherein
the core of the first multicore fiber and the core of the second multicore fiber are disposed on a plurality of concentric circles in which a center of each multicore fiber is a center, and
some or all of cores to be connected are selected from cores disposed on the concentric circles having radii different from one another.

5. The multicore fiber transmission line according to claim 1, wherein disposition of cores of the first multicore fiber and disposition of cores of the second multicore fiber are same, and the cores are disposed in positions forming rotational symmetry with respect to a center.

6. The multicore fiber transmission line according to claim 5, wherein the cores of the first multicore fiber and the cores of the second multicore fiber are connected while being opposed to each other in the rotationally symmetrical positions.

7. The multicore fiber transmission line according to claim 1, wherein the cores of the first multicore fiber and the cores of the second multicore fiber are connected by fusion-splicing.

8. The multicore fiber transmission line according to claim 1, wherein the cores of the first multicore fiber and the cores of the second multicore fiber are connected by an optical connector.

9. A multicore fiber transmission system comprising:
a multicore fiber transmission line in which a plurality of multicore fibers including a first multicore fiber and a second multicore fiber are connected in series with respect to each core, and cores of the first multicore fiber and cores of the second multicore fiber to be connected are selected in such a way that a variation in loss among a plurality of cores to be connected between the first multicore fiber and the second multicore fiber is reduced;
a loss measurement instrument configured to measure the loss before the connection; and
a fusion splicer configured to directly fusion-splice the first multicore fiber and the second multicore fiber.

10. The multicore fiber transmission system according to claim 9, wherein the fusion splicer includes a mechanism of confronting a cross-section of the first multicore fiber and a cross-section of the second multicore fiber to be opposed to each other on a straight line and rotating, on the straight line, the cross-section of the second multicore fiber with respect to the cross-section of the first multicore fiber.

11. The multicore fiber transmission system according to claim 10, wherein the fusion splicer performs the fusion-splicing at an angle of the rotation in which a variation of the loss on a path constituted of the connected cores is reduced.

12. The multicore fiber transmission system according to claim 9, wherein the loss measurement instrument measures, for each core, the loss by using reference light propagating through a point subjected to the fusion-splicing.

13. A multicore fiber connection method of connecting a plurality of multicore fibers including a first multicore fiber and a second multicore fiber in series with respect to each core, the method comprising
selecting a core of the first multicore fiber and a core of the second multicore fiber to be connected in such a way that a variation in loss among a plurality of cores to be connected between the first multicore fiber and the second multicore fiber is reduced.

14. The multicore fiber connection method according to claim 13, further comprising performing the connection between a single-core fiber included in a fan-out connected to the first multicore fiber and a single-core fiber included in a fan-in connected to the second multicore fiber.

15. The multicore fiber connection method according to claim 14, further comprising selecting a core of the first multicore fiber and a core of the second multicore fiber to be connected to each other, based on a connection relation between a single-core fiber included in the fan-out and a single-core fiber included in the fan-in.

16. The multicore fiber connection method according to claim 13, further comprising:
disposing the core of the first multicore fiber and the core of the second multicore fiber on a plurality of concentric circles in which a center of each multicore fiber is a center; and
selecting some or all of cores to be connected from among cores disposed on the concentric circles having radii different from one another.

17. The multicore fiber connection method according to claim 13, wherein disposition of the core of the first multicore fiber and disposition of the core of the second multicore fiber are same, and the cores are disposed in positions forming rotational symmetry with respect to a center.

18. The multicore fiber connection method according to claim 13, further comprising connecting, by fusion-splicing, the core of the first multicore fiber and the core of the second multicore fiber.

19. The multicore fiber connection method according to claim 13, further comprising:
measuring the loss before the connection; and
directly fusion-splicing the first multicore fiber and the second multicore fiber.

20. The multicore fiber connection method according to claim 19, further comprising:
confronting a cross-section of the first multicore fiber and a cross-section of the second multicore fiber to be opposed to each other on a straight line; and
rotating, on the straight line, the cross-section of the second multicore fiber with respect to the cross-section of the first multicore fiber.
